(19) United States
(12) Patent Application Publication
(10) Pub. No.: US 2026/0262137 A1
(43) Pub. Date: Sep. 3, 2026

(54) HEATING DEVICE FOR DISH WASHER AND CLOTHINGTREATMENT DEVICE

(71) Applicant: DSW INC., Yongin-si, Gyeonggi-do (KR)

(72) Inventor: Jin Doo KIM, Yongin-si (KR)

(73) Assignee: DSW INC., Yongin-si, Gyeonggi-do (KR)

(21) Appl. No.: 18/994,543

(22) PCT Filed: Jul. 21, 2022
(86) PCT No.: PCT/KR2022/010718

§ 371 Date: Jan. 14, 2025

(30) Foreign Application Priority Data
Jul. 14, 2022 (KR) 10-2022-0086837

(51) Int. Cl. H05B 1/02; D06F 39/04; H05B 3/03; H05B 3/04; H05B 3/06

(52) U.S. Cl. CPC H05B 1/0283; D06F 39/04; H05B 3/03; H05B 3/06; H05B 3/04; H05B 2203/021

(57) ABSTRACT

A heating device installed in a reservoir space to heat water, including: a heating plate, a heating electrode layer formed on the inner surface of the heating plate, a housing which couples the heating plate to a lower opening portion such that the heating surface is exposed, a bracket, a pair of first lead electrodes each having a first contact terminal at one end and a first lead terminal at the other end and integrally coupled to the bracket, and a pair of contact guide members coupled to the inside of the housing and having first press protrusions. In some embodiments, the heating device may include a pair of contact guide members coupled to the inside of the housing and having first pressing protrusions which press the first lead electrodes so that the first contact terminals come into contact with the first electrode pads.

### TECHNICAL FIELD

The present invention relates to a heating device, and more particularly, to a heating device installed in a dishwasher, a washing machine, or the like to instantly heat water for washing.

### BACKGROUND ART

In general, a dishwasher is a home appliance that washes food residue from the surface of dishes using high-pressure wash water sprayed from a spray nozzle. The dishwasher is equipped with a heating device for heating the wash water at a high temperature, and the heating device heats the wash water to a predetermined temperature and then the washing is performed by spraying the heated water.

In addition, recently, washing machines capable of boil washing or steam washing by heating washing water inside a water storage tank have been released. The washing machine is also configured to be equipped therein with a heating device so that introduced wash water is heated to a predetermined temperature and then the washing process is performed.

The heating device is integrally provided inside the dishwasher or the washing machine in the above manner and the heating device operates to heat water to an appropriate temperature for washing even when the water is introduced at room temperature, and accordingly, there is no need to connect a separate water tap for hot water supply.

FIG. 1 is a sectional view showing the general configuration of a drum washing machine; and

FIG. 2 is a perspective view showing a heating device for the drum washing machine according to the conventional art.

Referring to FIG. 1, a drum washing machine generally includes a cabinet 1 defining an internal storage space, a water storage tank (or tub) 2 installed inside the cabinet 1, a washing tank (or drum) 3 rotatably disposed inside the water storage tank 2, a heating device (or heater) 4 installed between the water storage tank 2 and the washing tank 3, and a driving motor 5 for rotating the washing tank 3. In addition, the drum washing machine is provided with a water supply port and a detergent supply port in an upper part of the cabinet 1, and provided with a drain port in a lower part thereof.

The heating device 4 is configured as a sheath heater to boil water or generate steam for boil-washing, steam-cleaning or sterilization. Referring to FIG. 2, the heating device 4 includes a heating unit 11 for generating heat, a bracket 12 for fixing one end of the heating unit 11 and mounted on the water storage tank 2, and a terminal 13 passing through the bracket 12 and connected to the inside of the heating unit 11 to supply electricity. A coil-shaped heating wire (not shown) is provided inside the heating unit 11, and the heating wire is connected to the terminal 13 via a temperature fuse (not shown) as a medium for preventing overheating. The heating device having the above configuration may be applied to dishwashers, dryers, and refreshers in addition to washing machines. When the water storage tank 2 is supplied with and filled with water, the heating device 4 operates to heat the water, and after the water is heated to a predetermined temperature, each device operates to perform processes such as washing, cleaning, drying, and refreshing,

Meanwhile, tap water supplied to the water storage tank contains limestone ingredients (water containing such ingredients is called ‘hard water’). The limestone ingredients contained in the tap water adhere to the high-temperature surface of the heating device due to heat generated when the heating device boils the water, thereby forming a lime layer. The lime layer occurring in the hard water blocks direct contact between the heating surface and the water, and accordingly the heating unit may overheat, thereby damaging the heating surface or shortening a lifespan of the heating device.

In addition, the conventional heating devices applied to devices such as drum washing machines and dishwashers operate after the water storage tank is completely filled with water, that is, after the supply of washing water or cleaning water is completed. Thus it may take a lot of time from the time water is supplied until the water is heated and then the washing or cleaning process is performed.

### DISCLOSURE

### Technical Problem

The present invention is proposed to solve the above problems, an object of the present invention is to provide a heating device capable of the problems of malfunction and shortened lifespan due to formation of a lime layer in a hard water condition.

In addition, an object of the present invention is to provide a heating device capable of shortening the processing time from when water is supplied to when the water is heated and then washing and cleaning are performed.

In addition, an object of the present invention is to provide a heating device capable of improving the accuracy of water level detection for water supplied into the water storage tank. In addition, an object of the present invention is to provide a heating device capable of preventing malfunction due to poor contact by ensuring stable contact between a contact terminal of a lead electrode for supplying power and an electrode pad of a heating electrode layer for heating.

In addition, an object of the present invention is to provide a heating device capable of preventing electrical interference (e.g., sparks) that may occur between multiple lead electrodes and sensor electrodes, so as to ensure safety in use.

### Technical Solution

A heating device of the present embodiment for solving the above-mentioned problems is a heating device installed in a reservoir space inside a dish washer and a clothing treatment device to heat water, and includes: a heating plate as a plate having a predetermined thickness and formed on an outer surface thereof with a heating surface; a heating electrode layer formed on an inner surface of an opposite surface of the heating surface of the heating plate and having one side provided with a pair of first electrode pads; a housing for coupling the heating plate to a lower opening thereof to expose the heating surface; a bracket coupled while sealing side openings; a pair of first lead electrodes, each having a first contact terminal formed at one end thereof and a first lead terminal at an opposite end thereof and integrally coupled to the bracket while passing therethrough; and a pair of contact guide members coupled to an inside of the housing and each having a first pressing protrusion for pressing the first lead electrode so that the first contact terminal comes into contact with the first electrode pad.

In addition, the heating device of the present embodiment further includes:, a resistance electrode layer formed on the inner surface of the heating plate in a region that does not overlap with the heating electrode layer, and having one side provided with a pair of second electrode pads; and a pair of second lead electrodes, each having a second contact terminal formed at one end thereof and a second lead terminal at an opposite end thereof and integrally coupled to the bracket while passing therethrough, wherein the contact guide member may be further provided with a second pressing protrusion for pressing the second lead electrode to bring the second contact terminal into contact with the second electrode pad.

In addition, the heating device further includes: a water level sensor integrally coupled to the bracket had having one end exposed to the housing, and water may be heated when the water level sensor detects that water is filled.

In addition, the housing may be formed therein with a water channel isolated from an outside by a barrier wall having a through-hole through which the water is introduced or discharged, and the water level sensor may be installed to have one end exposed to the water channel to detect a water level of the water introduced into the water channel.

In addition, the heating surface may be formed by bending a central region of the heating plate to be concave inward.

In addition, the heating surface may have an inclined structure to have different bending depths.

### Advantageous Effects

According to the present invention, the heating electrode pattern is formed at a predetermined interval and width to eliminate the heating interference caused by the formation of a lime layer, so that problems with malfunction and damage to the heating device caused by the lime layer can be solved.

In addition, according to the present invention, the water level sensor detects the water level under conditions of minimizing waves of supplied water, so that the accuracy of water level detection can be remarkably improved.

In addition, according to the present invention, the heating is performed when water begins to fill the bottom of the water storage tank, so that the overall time of heating, washing or cleaning process can be reduced.

In addition, according to the present invention, the guide member formed of an elastic material provides adequate contact force between the lead electrode and the electrode pad, so that the malfunction due to poor contact can be prevented.

In addition, according to the present invention, the lead electrode and the sense electrode (resistance electrode) are prevented from being positioned on the same horizontal plane, thereby preventing electrical interference therebetween, so that safety in use can be improved.

### DESCRIPTION OF DRAWINGS

FIG. 1 is a view showing the general configuration of a drum washing machine.

FIG. 2 is a view showing a heating device for a drum washing machine according to the conventional art.

FIG. 3 is a view showing a heating device for a drum washing machine according to the present embodiment.

FIG. 4 is a view of the heating device of FIG. 3 when viewed from the bottom.

FIG. 5 is an exploded view showing the heating device of FIG. 3.

FIG. 6 is a view showing a section in the A-A direction of the heating device of FIG. 3.

FIG. 7 is a view showing a section in the B-B direction of the heating device of FIG. 3.

FIG. 8 is a conceptual view showing a state in which the heating device of FIG. 3 is immersed in washing water.

FIG. 9 is a view showing an internal structure of a housing serving as a main part of the heating device according to the present embodiment.

FIG. 10 is a view showing a contact guide member serving as a main part of FIG. 9.

FIG. 11 is a view showing an electrode connection structure of the heating device according to the present embodiment.

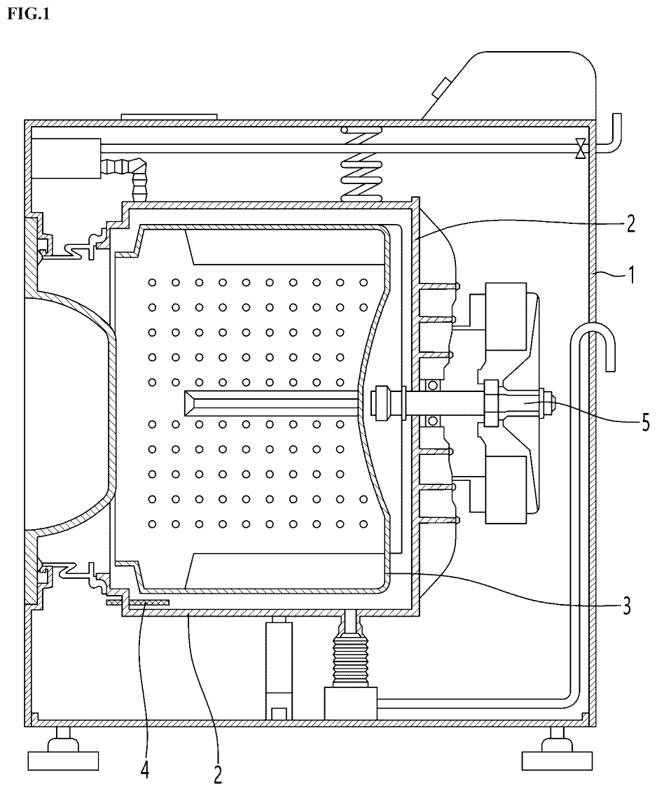

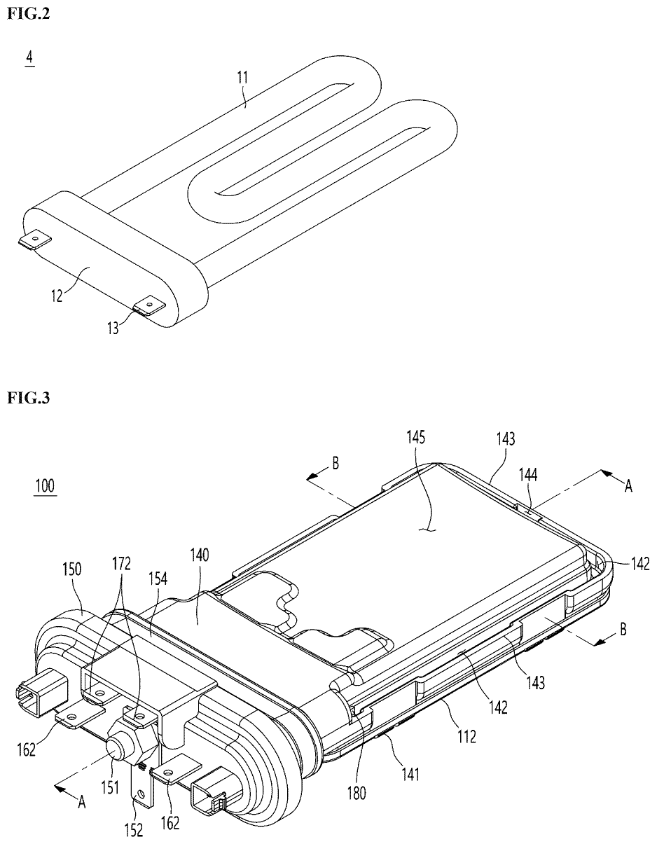

### BEST MODEL

### Mode for Invention

Technical problems implemented by the present invention and practices of the present invention will be apparent from the preferred embodiments described as follows. Hereinafter, the preferred embodiments of the present invention will be described in detail with reference to the accompanying drawings.

It will be understood that differences in the embodiments described later are not mutually exclusive. In other words, it will be understood that the described specific shapes, structures and characteristics may be implemented in other embodiments with respect to one embodiment, and the positions or arrangements of individual components within each disclosed embodiment may be modified, without departing from the technical spirit and scope of the present invention. Similar reference numerals in the drawings denote the same or similar functions throughout several aspects, and the length, area, thickness and the like as well as the shape thereof may be exaggerated for convenience. In the description of this embodiment, expressions such as up, down, front, back, first, second and the like indicate relative positions, directions, or orders, and their technical meanings are not bound by lexical meanings.

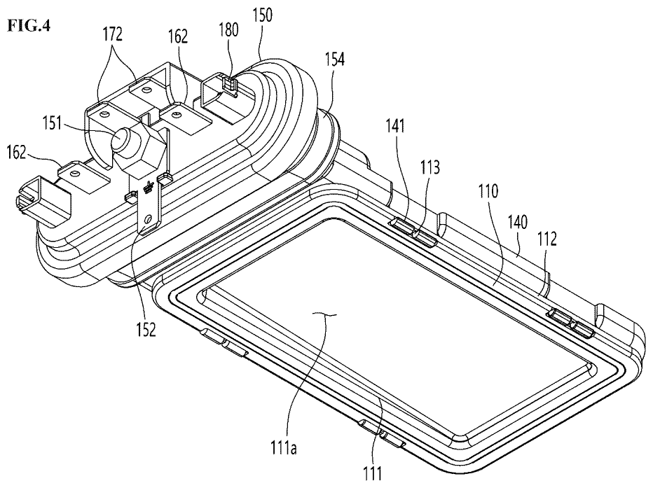

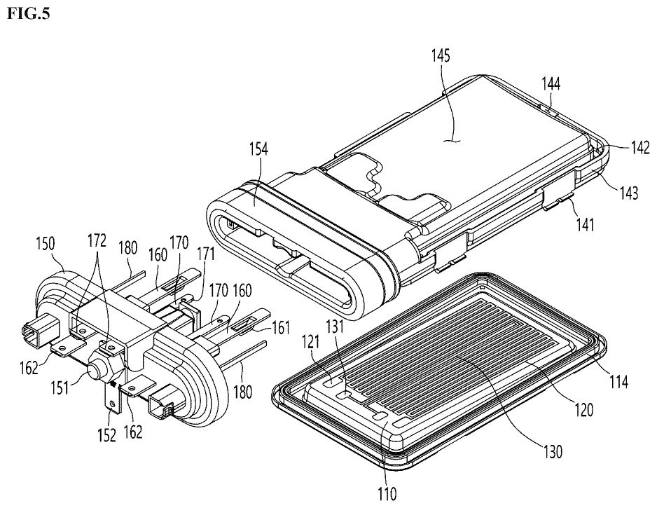

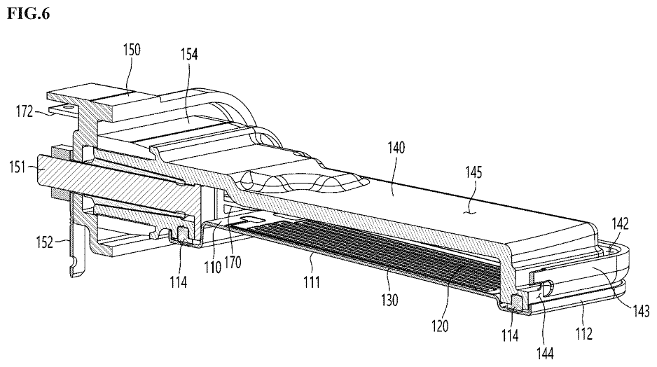

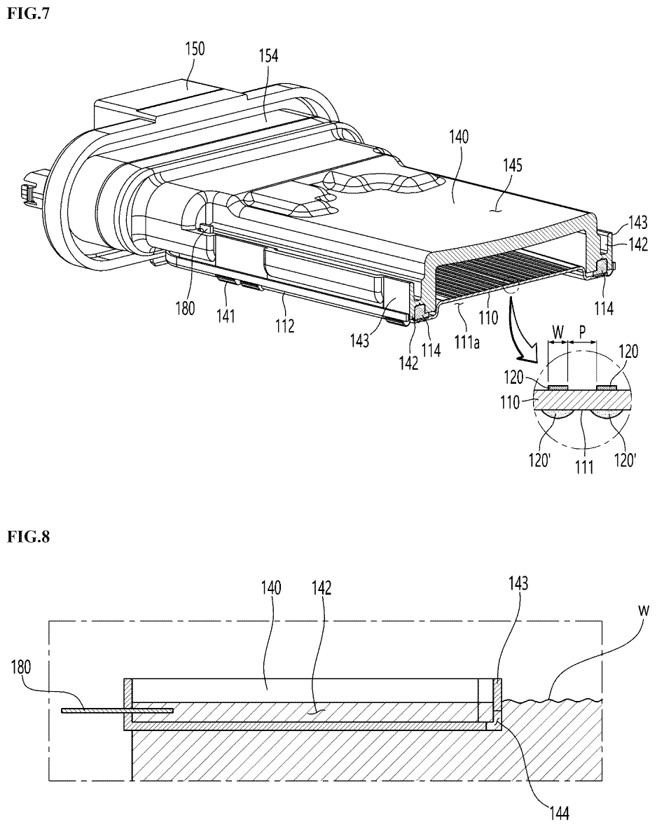

FIGS. 3 and 4 are views of the heating device for the drum washing machine according to the present embodiment when viewed from the top and the bottom; FIG. 5 is an exploded view showing the heating device of FIG. 3; FIGS. 6 and 7 are views showing sections in the A-A direction and the B-B direction of the heating device of FIG. 3; and FIG. 8 is a conceptual view showing a state in which the heating device of FIG. 3 is immersed in washing water. The heating device of the present embodiment is described as an example of a device applied to a washing machine to heat washing water.

First, referring to FIGS. 3 to 5, a heating device 100 of the present embodiment includes: a heating plate 110 for generating heat, a heating electrode layer 120 formed on one surface (upper surface) of the heating plate, a resistance electrode layer 130 formed on the upper surface of the heating plate 110 in a region that does not overlap with the heating electrode layer 120, a housing 140 for accommodating and protecting the heating plate 110, a bracket 150 for allowing the heating device 100 to be mounted to a water storage tank 2 of the washing machine, a first lead electrode 160 coupled to the bracket 150 to supply power to the heating electrode layer 120, a second lead electrode 170 coupled to the bracket 150 to supply power to the resistance electrode layer 130, and a water level sensor 180 mounted on the housing. According to the heating device 100, when power is supplied through a pair of first lead electrodes 160, current flows along the heating electrode layer 120 to generate high temperature heat in the heating electrode layer 120, and the generated heat is released through the heating plate 110 to heat water coming into contact with the surface of the heating plate 110.

To this end, the heating plate 110 is formed of a material having insulation properties as well as excellent thermal conductivity. In addition, the heating plate 110 is composed of a plate having a predetermined thickness, has a central region bent concavely, and has a concave surface (bottom surface) formed therein with a heating surface 111 for heating water in contact. For example, the heating plate 110 is composed of a rectangular plate formed of an SUS material, and has the central region is bent concavely into a rectangular shape.

Meanwhile, when high temperature heat is generated in the heating electrode layer 120, the heating plate (110) may have a temperature deviation between the central region formed with the electrode layer and the edge region from which the electrode layer is absent, and the temperature deviation may cause the plate to warp or twist, thereby deforming the shape. Since the thermal deformation of the heating plate 110 due to the temperature deviation becomes more significant when the plate is thinner, the simple plate-shaped heating plate 110 is required to have a thickness greater than a predetermined level to prevent the thermal deformation. Accordingly, the simple plate-shaped heating plate 110 may have limitations in reducing the thickness, the heating device may have the increased weight, and manufacturing costs may be increased due to material costs,

However, when a bending processing is applied to form the concave heating surface 111 in the central region as in the present embodiment, both sides of the heating surface 111 function as reinforcing ribs, so that the thermal deformation can be prevented while reducing the thickness of the heating plate 110. For example, the heating plate 110 of the present embodiment may be configured as a plate having a thin thickness of 0.6 mm or less.

In addition, according to the heating plate 110 of the present embodiment as shown in FIGS. 4 and 6, the concave heating surface 111 has an inclined structure. In other words, a heating space 111a in the lower part of the heating plate 110 formed by the concave groove has one side formed relatively deep so as to be gradually shallower toward an opposite side.

The heating device 100 operates while being immersed in water inside the washing machine, and contaminated wash water after completion of washing is discharged. It is preferable to install the concave heating surface 111 to face downward since the wash water is required not to remain on the heating surface 111 of the concave groove. Accordingly, the surface (lower surface) of the heating plate 110 defines the heating surface 111 having the upwardly concave groove shape and the heating space 111a is formed therebelow. When the water storage tank 2 of the washing machine is filled with water, an air pocket may be formed in the concave heating space 111a.

Meanwhile, in the case that the heating surface 111 is formed horizontally parallel to a water surface, the air pocket may be formed over the entire region of the heating surface 111 and the water may not come into contact with the heating surface 111 due to the air pocket even when the water storage tank 2 is filled with the water, and accordingly the heating plate 110 may become overheated and damaged. However, when the heating surface 111 has an inclined surface structure as in the present embodiment, the air pocket is formed only in some space at the top of the heating space Illa and formed in a region in which the electrode layer is not formed, so that the heating plate 110 may be prevented from being overheated and damaged due to the air pocket.

In addition, the heating plate 110 of the present embodiment has an edge end finished to be bent or curled to one side to form a reinforcing flange 112. The reinforcing flange 112 may prevent deformation of the heating plate 110. It is preferable that the reinforcing flange 112 be formed at a lower height than the heating surface 111 not to interfere with the process of forming the heating electrode layer 120 on the heating surface 111.

In addition, the heating plate 110 of the present embodiment may be coupled to the housing 140 by using a fastening tool such as a screw when, but may be coupled by using the structures of the heating plate 110 and the housing 140. To this end, a plurality of fastening holes 113 are further formed in the reinforcing flange 112 of the heating plate 110, and a plurality of hook-shaped fastening protrusions 141 are formed at positions corresponding to the fastening holes 113 in the housing 140.

The heating electrode layer 120 may be formed by printing a conductive heating paste having a predetermined resistance on the surface of the heating plate 110, and formed on the surface (upper surface) of the heating plate 110 in the opposite side of the heating surface 111. The heating electrode layer 120 may be formed in a band shape having a predetermined width and length, and has both ends provided with a pair of first electrode pads 121 with which the first lead electrode 160 comes into contact. The heating electrode layer 120 may be formed as series or parallel electrode lines between the pair of first electrode pads 121.

Meanwhile, referring to FIG. 7, the electrode lines forming the heating electrode layer 120 are formed to have a predetermined width W and spacing P. The heat generated from the heating electrode layer 120 is transferred to the heating plate 110 to heat water coming into contact with the heating plate 110. A lime layer 120′ is formed corresponding to the position of the heating electrode layer 120 is formed on the opposite surface(that is, heating surface) of the heating plate 110 formed thereon with the heating electrode layer 120.

The lime layer 120′ may gradually grow around the electrode lines of the heating electrode layer 120, and may be connected to an adjacent lime layer 120′ as it grows. In this case, the heating surface 111 is covered with the lime layer 120′, and the heat transferred from the heating electrode layer 120 may not be released quickly, thereby finally causing the heating device 100 to have a malfunction or damage.

In order to prevent this situation, the heating electrode layer 120 is formed to have a predetermined width W and spacing P, and in the present embodiment, the heating electrode layer 120 is formed to have the spacing P of at least ⅓ or more of the width W (P≥⅓W). In other words, it is desirable that the heating electrode layer 120 be formed with the widest possible width W and narrowest spacing P as possible in order to transfer high temperature heat to the heating plate 110, however, the spacing P of at least ⅓ or more of the width W is required to be ensured between adjacent electrode lines forming the heating electrode layer 120 in order to prevent malfunction or damage due to the lime layer 120′.

The resistance electrode layer 130 is formed by printing a conductive heating paste having a predetermined resistance on the region in which the heating electrode layer 120 is not formed, that is, on the surface of the heating plate 110 between the heating electrode layers 120. The resistance electrode layer 130 may formed in a band shape having a predetermined width and length, and has both ends provided with a pair of second electrode pads 131 with which the second lead electrode 170 comes into contact.

The resistance electrode layer 130 enable a prediction of a temperature of the heated water by measuring a resistance of the heating electrode layer 120 according to a temperature. In general, since the resistance also changes depending on temperature, the resistance of the heating electrode layer 120 changing according to the temperature of the heating plate 110 is measured through the resistance electrode layer 130, thereby controlling the power supplied to the heating electrode layer 120, so that the heating plate 110 for heating the water is heated to a predetermined constant temperature. To this end, the resistance electrode layer 130 may be formed by printing a conductive paste which is the same material as the heating electrode layer 120. In addition, the resistance electrode layer 130 is connected to an external resistance measurement module through the second lead electrode 170.

Meanwhile, the resistance electrode layer 130 may be used to predict the temperature of water by measuring the resistance of the heating electrode layer 120, however, may also function as another heating electrode layer for heating the heating plate 110. In other words, the heating device 100 may also be used for the purpose of applying heat to a local site using the heating plate 110 as needed. In this case, since the resistance electrode layer 130 is formed to have a relatively narrow area while being formed of a conductive paste which is the same material as the heating electrode layer 120, the power may be applied to the resistance electrode layer 130, so that the heating plate 110 may generate heat at a local site. Accordingly, the resistance electrode layer 130 may be configured to be selectively connected to a resistance measurement module or power supply module of the outside through the second lead electrode 170, Since a lime layer may be formed also by the resistance electrode layer 130 when the resistance electrode layer 130 functions as a heating electrode layer, it is preferable that the resistance electrode layer 130 be formed to have a spacing of at least ⅓ or more based on the width, like the heating electrode layer 120.

In the above manner, even when the heating electrode layer 120 and the resistance electrode layer 130 formed by printing the conductive paste are defective during the printing process, the heating plate 110 may be reused by washing the printed layer. Accordingly, waste of resources due to defects in the manufacturing process can be minimized, and environmental pollution can be prevented.

The housing 140 is formed of a non-conductive material having a high heat resistance, so that the heating plate 110 is coupled to a lower opening and the bracket 150 is coupled to a side opening thereof. The heating plate 110 and the bracket 150 are connected to the housing 140 via a first sealing member 114 and a second sealing member 154, respectively. The heating plate 110, the first lead electrode 160 and the second lead electrode 170 are accommodated in an internal space of the housing 140 so as to be insulated and protected from the outside.

In addition, the housing 140 is formed along an upper edge thereof with a concave groove-shaped water channel 142. The water channel 142 is isolated from the outside through a barrier wall 143 at an outer end of the housing and connected to the outside through a through-hole 144 at a front of the housing 140. Accordingly, when the water storage tank 2 is filled with water while the heating device 100 is installed in the washing machine, the water is introduced into the water channel 142 through the through-hole 144 and filled therein. Upon draining after the washing is finished, the water filled in the water channel 142 is drained through the through-hole 144 again. One end of the water level sensor 180 is exposed in the water channel 142 to detect a water level of the water filled in the water storage tank 2.

In addition, the housing 140 may have an upper surface formed thereon with an avoidance groove 145 having a concave curved shape. The avoidance groove 145 is formed as a curved surface in a direction corresponding to a circumferential surface of a washing tank 3, and may preferably have a curvature corresponding to the circumferential surface of the washing tank 3.

In general, a drum washing machine is equipped with a drive motor 5 having a rotation shaft on one side of a cabinet 1, and a washing tank 3 has one side coupled to the rotation shaft and arranged horizontally. When the rotation shaft rotates, the washing tank 3 also rotates. the one side of the washing tank 3 is fixed and rotated by the rotation shaft, but an opposite side (door side) rotates in a trajectory larger than an actual radius of the washing tank 3 while shaking slightly. In addition, the heating device 100 has a heating region coupled to be positioned at a lower part of the washing tank 3 while overlapping with the washing tank 3, and is coupled at a position close to the washing tank 3 as possible in order to efficiently utilize the space inside the washing machine.

Since the washing tank 3 rotates in the trajectory larger than the actual radius, there is a risk that the washing tank 3 may collide with the heating device, that is, the housing 140. Thus, according to the heating device 100 of the present embodiment, the avoidance groove 145 having a concave curved surface corresponding to the circumferential surface of the washing tank 3 is formed on the upper surface of the housing 140, so that the collision or interference between the housing 140 and the washing tank 3 may be prevented upon operation of the washing machine. In addition, according to the heating device 100 of the present embodiment, the avoidance groove 145 is formed in the housing 140, thereby allowing replacement of a heating device having a sheath structure with a heating device having a flat structure without changing the structure of the conventional washing machine, so that compatibility of heating devices may be accomplished.

The bracket 150 is coupled to the housing 140 to seal the side opening of the housing 140 to fix the first and second lead electrodes 160 and 170 and the water level sensor 180 and mount the heating device 100 to the water storage tank 2). The bracket 150 may be provided with a fastening tool 151 of a bolt or nut structure so as to be fastened to the housing 110, and may have an outer side additionally provided with a ground terminal 152.

The first lead electrode 160 is configured to supply the power to the heating electrode layer 120, and a pair of conductive metal wires may be used. The first lead electrode 160 has one end formed therein with a first contact terminal 161 extending to the inside of the housing 140 and protruding downward to come into contact with the first electrode pad 121, and an opposite end exposed to the outside of the bracket 150 to form a first lead terminal 162 so as to be connected to the power supply module (not shown).

The second lead electrode 170 is configured to supply the power to the resistance electrode layer 130, and a pair of conductive metal wires may be used. The second lead electrode 170 has one end formed therein with a second contact terminal 171 extending to the inside of the housing 140 and protruding downward to come into contact with the second electrode pad 131, and an opposite end exposed to the outside of the bracket 150 to form a second lead terminal 172 so as to be connected to the resistance measurement module or the power supply module (not shown).

The second sealing member 154 is coupled, in advance, to an outer circumferential surface of the housing 140 to which the bracket 150 is coupled. The second sealing member 154 is interposed between the housing 140 and the bracket 150 to seal a space therebetween and seals a space between the housing 140 and the water storage tank 2 when the bracket 150 is fastened to the water storage tank 2 so as to prevent the water filling the water storage tank 2 from leaking.

The water level sensor 180 is configured to detect the water level of water (washing water) filling the water storage tank to allow the heating device to operate. When water is detected by the water level sensor 180, the heating device 100 is in an operable state, that is, the water is filled to the level at which the heating device 100 is immersed. Thus, the heating device may operate during the process of filling the water into the water storage tank 2. Accordingly, since the heating device 100 operates in advance to heat the water before the water storage tank is completely filled therein with a sufficient amount of water for washing, the time for heating the water to a temperature applicable for the washing may be shortened. To this end, the water level sensor 180 may be composed of a pair of sensor electrodes having one end extending into the water channel 142 of the housing 140 and an opposite end exposed to the outside of the bracket 150, and may be configured, without limitations, as any types of sensor members capable of detecting the water level.

In addition, the water level sensor 180 is installed in the water channel 142 protected from the outside by a barrier wall 143. In general, waves are generated during the process of filling the water storage tank 2 with water, and the accuracy of water level detection may be significantly decreased by the waves. Accordingly, as shown in FIG. 8, when the water channel 142 is protected by the barrier wall 143, the water filled outside the water channel 142 generates strong waves w, but the water introduced into the water channel 142 rises at a constant level without generating waves, and accordingly, the accuracy of water level detection may be improved.

Meanwhile, as shown in FIG. 5, the bracket 150 fixes the first lead electrode 160, the second lead electrode and the water level sensor 180, thereby forming one module. Each one end of the first lead electrode 160, the second lead electrode 170 and the water level sensor 180 extends to the inside of the bracket 150, and each opposite end is exposed to the outside of the bracket 150. Since the bracket 150 is formed of an injection molded insulating material, and the first lead electrode 160, the second lead electrode and the water level sensor 180 are formed of a conductive metal material, the first lead electrode 160, the second lead electrode 170 and the water level sensor 180 may be integrally formed by a double injection (insert molding) process as inserts.

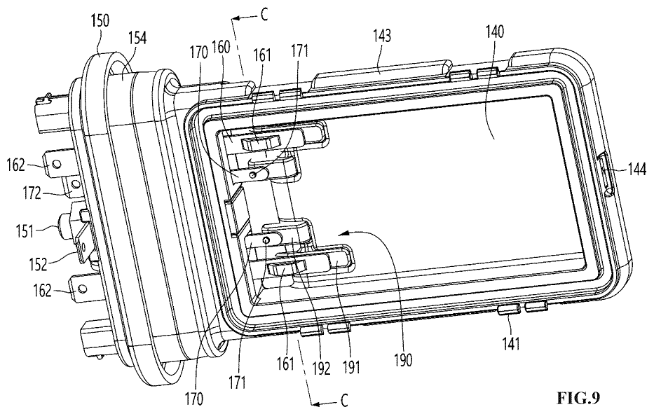

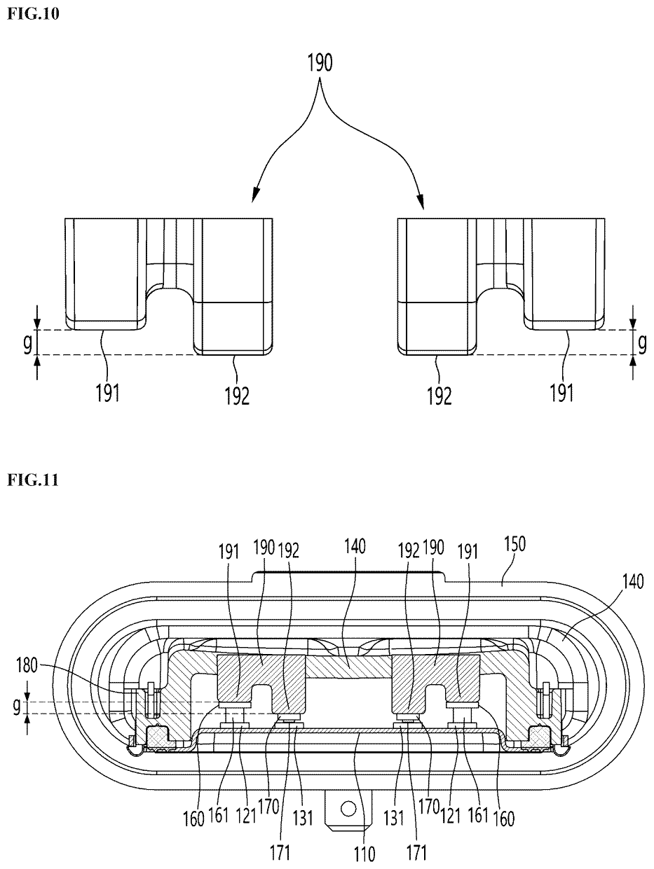

FIG. 9 is a view showing an internal structure of the housing serving as a main part of the heating device according to the present embodiment; FIG. 10 is a view showing a contact guide member serving as a main part of FIG. 9; and FIG. 11 is a view showing an electrode contact structure of the heating device according to the present embodiment.

The heating device 100 of the present embodiment further includes a pair of contact guide members 190 provided inside the housing 140. The contact guide member 190 guides electrical contact of the first lead electrode 160 and the second lead electrode 170.

The first lead electrode 160 and the second lead electrode 170 have the first contact terminal 161 and the second contact terminal 171 coming into contact with the first electrode pad 121 and the second electrode pad 131 to supply the power to the heating electrode layer 120 and the resistance electrode layer 130, respectively. Accordingly, electrical contact is required to be firmly performed between the first contact terminal 161 and the first electrode pad 121, and between the second contact terminal 171 and the second electrode pad 131.

According to the heating device 100 of the present embodiment, in the process of assembling the bracket 150 to the housing 140, the first and second lead electrodes 160 and 170 are inserted into the housing, and thus the first contact terminal 161 and the second contact terminal 171 come into contact with the first electrode pad 121 and the second electrode pad 131, respectively. In this process, there is a risk of poor contact occurring between the first contact terminal 161 and the first electrode pad 121, and between the second contact terminal 171 and the second electrode pad 131. Particularly, as in the present embodiment, when a surface (upper surface) of the metal plate 110 formed thereon with the first electrode pad 121 and the second electrode pad 131 are inclined downward (that is, inclined in a reverse direction) with respect to the direction in which the lead electrodes 160 and 170 are assembled, there is a very high possibility that a gap has formed between the contact terminal 161 and 171and the electrode pad 121 and 131), resulting in poor contact therebetween.

Accordingly, the contact guide member 190 presses the lead electrodes 160 and 170 when the lead electrodes 160 and 170 are inserted into the housing 140, thereby guiding the contact terminals 161 and 171 to come into contact with the electrode pad 121 and 131. To this end, the contact guide member 190 may be formed of an elastic material having a predetermined elasticity, and may be composed of, for example, a silicon block. The contact guide member 190 may be formed of various types of elastic materials, such as an elastic piece, an elastic bumper and a spring, in addition to the silicone block.

Specifically, as shown in FIG. 10, the contact guide member 190 includes a first pressing protrusion 191 for pressing the first lead electrode 160 and a second pressing protrusion 192 for pressing the second lead electrode 170. The first pressing protrusion 191 and the second pressing protrusion 192 are formed parallel to each other at positions in which the first lead electrode 160 and the second lead electrode 170 are inserted. Particularly, the first pressing protrusion 191 and the second pressing protrusion 192 protrude downwards to a predetermined length, but protruding to different lengths to form a step g.

Referring to FIGS. 9 and 10, the pair of contact guide members 190 are coupled to the inner surface of the housing 140 at a position in which the lead electrodes 160 and 170 are inserted, and the first pressing protrusion 191 and the second pressing protrusion 192 press the first lead electrode 160 and the second lead electrode 170, respectively, when the bracket 150 is assembled to the housing 140, so that the first contact terminal 161 and the second contact terminal 171 come into contact with the first electrode pad 121 and the second electrode pad 131. The first pressing protrusion 191 and the second pressing protrusion 192 have the elasticity, so that predetermined contact resistances (contact force) are maintained constant between the first and second contact terminals 161 and 171 and the first and second electrode pads 121 and 131.

In addition, since the first pressing protrusion 191 and the second pressing protrusion 192 have the step g having different heights at the ends thereof, positions of the first lead electrode 160 and the second lead electrode 170 are offset with respect to the horizontal direction by an amount corresponding to the step g. Accordingly, the first lead electrode 160 and the second lead electrode 170 are not located on the same horizontal line, so that electrical interference, which may occur therebetween, may be minimized. The first and second contact terminals 161 and 171 are formed to have different protruding lengths, so that the positions of the first lead electrode 160 and the second lead electrode 170 may be compensated to come into contact with the first and second electrode pads 121 and 131.

The exemplary embodiments of the present invention have been illustrated and described as above, but various modifications and other embodiments may be carried out by those skilled in the art. These modifications and the other embodiments are all intended to be considered and encompassed by the appended claims and do not depart from the true spirit and scope of the present invention.

1. A heating device, for a dish washer and a clothing treatment device, which is installed in a reservoir space inside the dish washer and the clothing treatment device to heat water, the heating device comprising:
a heating plate as a plate having a predetermined thickness and formed on an outer surface thereof with a heating surface;
a heating electrode layer formed on an inner surface of an opposite surface of the heating surface of the heating plate and having one side provided with a pair of first electrode pads;
a housing for coupling the heating plate to a lower opening thereof to expose the heating surface;
a bracket coupled while sealing a side opening;
a pair of first lead electrodes, each having a first contact terminal formed at one end thereof and a first lead terminal at an opposite end thereof and integrally coupled to the bracket while passing therethrough; and
a pair of contact guide members coupled to an inside of the housing and each including a first pressing protrusion for pressing the first lead electrode so that the first contact terminal comes into contact with the first electrode pad.

2. The heating device of claim 1, further comprising:
a resistance electrode layer formed on the inner surface of the heating plate in a region that does not overlap with the heating electrode layer, and having one side provided with a pair of second electrode pads; and
a pair of second lead electrodes, each having a second contact terminal formed at one end thereof and a second lead terminal at an opposite end thereof and integrally coupled to the bracket while passing therethrough, wherein
the contact guide member further includes a second pressing protrusion for pressing the second lead electrode to bring the second contact terminal into contact with the second electrode pad.

3. The heating device of claim 1, wherein the contact guide member is formed of an elastic material for maintaining a constant contact force between the first contact terminal (or the second contact terminal) and the first electrode pad (or the second electrode pad).

4. The heating device of claim 1, further comprising:
a water level sensor integrally coupled to the bracket had having one end exposed to the housing, wherein
water is heated when the water level sensor detects that water is filled.

5. The heating device of claim 4, wherein the housing is formed therein with a water channel isolated from an outside by a barrier wall having a through-hole through which the water is introduced or discharged, and the water level sensor is installed to have one end exposed to the water channel to detect a water level of the water introduced into the water channel.

6. The heating device of claim 1, wherein the heating surface is formed by bending a central region of the heating plate to be concave inward.

7. The heating device of claim 6, wherein the heating surface has an inclined structure to have different bending depths.

8. The heating device of claim 2, wherein the contact guide member is formed of an elastic material for maintaining a constant contact force between the first contact terminal (or the second contact terminal) and the first electrode pad (or the second electrode pad).
